(19) United States
(12) Patent Application Publication
(10) Pub. No.: US 2015/0135588 A1
(43) Pub. Date: May 21, 2015

(54) POTTED PLANT DISPLAY STAND

(71) Applicant: FRANC GERGEK, GATINEAU (CA)

(72) Inventor: FRANC GERGEK, GATINEAU (CA)

(21) Appl. No.: 14/083,038

(22) Filed: Nov. 18, 2013

(51) Int. Cl. A01G 9/02

(52) U.S. Cl. CPC A01G 9/02
USPC 47/65.5

(57) ABSTRACT

The potted plant display system of the present invention uses plant trays into which potted plants are placed. Watering of the potted plants is accomplished by filling the plant trays with water and allowing the soil within the pots to absorb the water in a bottom up fashion. Multi-tier or vertical displays are created by using the various display bases into which trays are placed. Plant trays within a tier are interconnected through a conduit system that transfers water from one plant tray to another. A single plant tray within a tier contains a draining adaptor through which water is drained onto a plant tray located on a tier directly below or into a bucket. Water level in the plant trays is controlled by the draining restrictor that is placed into the draining adaptor. During watering, water is applied to a plant tray positioned on the highest tier in a multi-tier display.

### FIELD OF THE INVENTION

The present invention relates to the field of plant watering systems.

The potted plant display system of the present invention uses plant trays into which potted plants are placed. Watering of the potted plants is accomplished by filling the plant trays with water and allowing the soil within the pots to absorb the water in a bottom up fashion. Multi-tier or vertical displays are created by using the various display bases into which trays are placed. Plant trays within a tier are interconnected through a conduit system that transfers water from one plant tray to another. A single plant tray within a tier contains a draining adaptor through which water is drained onto a plant tray located on a tier directly below or into a bucket. Water level in the plant trays is controlled by the draining restrictor that is placed into the draining adaptor. During watering, water is applied to a plant tray positioned on the highest tier in a multi-tier display. The conduit system fills all the trays on the same tier to the same level as controlled by the draining restrictor. Once the top tier has been filled, water will run through the draining adaptor and fill trays located on a tier directly below to the level controlled by a draining restrictor fitted within that tier. Filling subsequent tiers will continue until the last tier has been filled. Once the last tier has been filled, the water will run into the bucket or through a hose into a gutter on the floor. At this point watering is to be stopped. Water is left in the trays for several hours or overnight allowing the soil in the flower pots to saturate with water. To drain the display the draining restrictor in the lowest tier is removed. Water runs through the draining adaptor into the gutter. If the gutter in not located directly underneath the potted plant display stand, a suction system is used to transport the water to a remote gutter. The draining restrictor is removed from subsequent tiers as the previous tiers have been drained. This way water flow does not overwhelm the suction system and does not cause a spill. Once all the tiers are drained the suction can be turned off.

A single plant tray from the potted plant display stand is also described as used interchangeably by itself or within a potted plant display stand having two or more plant trays is also described.

### BACKGROUND

Watering of potted plants has long been an inconvenient task for commercial and at home planters. The inconvenience is only amplified with the task of watering multiple potted plants. Plants with dense foliage or blossoms are generally watered from the top, using a spray nozzle or a watering bucket. Most of the water sprayed onto the plants runs down the dense foliage and end up on the floor. In order to direct most of the water into the soil of each potted plant, the planter must push aside the dense foliage, locate the pot and pour water directly into the top soil. Water has to be applied relatively slowly in order to allow for absorption. The process is repeated for every single potted plant, and as such, it very time consuming and laborious. The inconvenience is further amplified by the fact that the amount of water required by each plant varies depending on size, foliage, and temperate conditions of the plants native environment. Accidental over watering leads to excess water leaking out from the bottom of the pot causing a mess on the floor and a potential slipping hazard. Insufficient watering will result in wasted plants and financial loss to commercial establishments.

The preferred method of watering plants is from the bottom. Water is absorbed by the soil, located within the pot of the potted plant. Once absorbed by the soil, the water is readily available for uptake but the plants through the root system. Water is absorbed as necessary by the plant through osmosis from the moist soil. Many pots come with saucers that hold excess water that wasn't absorbed by the soil. As such, the saucers main function is to prevent spilling of excess water. Saucers are not designed for watering of the plants from the bottom, and do not alleviate the inconvenience associated with watering plants.

Various attempts have been made to alleviate the inconvenience associated with watering of potted plants. Devices such as U.S. Pat. No. 6,243,985 (Miller), U.S. Pat. No. 5,409,510 (Houweling), or U.S. Pat. No. 4,170,844 (Steele) provie such examples of potted plant watering systems.

Miller discloses a customizable potted plant watering apparatus. The apparatus is made up of a variety of interconnecting parts to form one or more separate elongate trays which are arranged in any fashion but generally one above the next. Water is introduced to potted plants through the tray. The trays are interconnected by intricate and complicated system which involves multitude of rubber tubes. Two sets of tubes are required for each tray, a drain tube and a fill tube. The apparatus becomes expensive to produce and hard to maintain. With the plethora of tubes, the apparatus is unappealing to the commercial market as the potential for massive water spill is increased. One accidental pull at the tubes by a customer will cause all of the water in the trays to be spilled out onto the floor. Additionally, the trays do not have a system where the water level within each tray can be adjusted depending on the potted plant water consumption and user preference.

Houweling discloses a watering gutter for use in a flood irrigation system. The system is comprised of multiple elongated trays. The tray is formed to contain two podiums for placement of the potted plants. Troughs outline the podiums within the tray. Each tray is independent. Water is introduced to potted plants through the tray. Water is introduced at the inlet and is drained at multiple locations along the troughs. As such, watering of the potted plants remains tedious as each tray needs to be independently filled while draining of water requires the release of three drain plugs from each tray. Additionally, the trays to not appear to have a mechanism for custom display configuration.

Steele discloses liquid circulating system in combination with an adjustable high intensity lighting system in which the feeding cycle and lighting cycle can be closely regulated to control the plant environment. Water is fed to the plants through a liquid circulating system in which the water is pumped to the upper tray and drained by gravity into the lower tray through drain tubes. The trays within the system are connected, but they are only connected vertically as gravity would not be able to push water horizontally to adjacent trays. Additionally, the system is not customizable and as such it cannot be formed to suit the customer's needs.

As such, there is a need for a potted plant display stand that can overcome the drawbacks as described above. Indeed, there is a need for a potted plant display stand that waters multiple potted plants from the bottom, contains the ability to vary the amount of water within each tray, and contains a watering system that interconnects the individual trays. Additionally, there is a need for a potted plant display stand that is customizable and to user specification, whether in a commercial or at home setting.

### SUMMARY

The present invention provides a potted plant display stand. In a first aspect of the present invention a potted plant display stand comprising a plant tray for displaying potted plants, a display base to support the plant tray, a draining adaptor positioned within the plant tray and a draining restrictor for controlling the level of water within the plant tray and for positioning in the draining adaptor is described.

In a second aspect of the present invention, a potted plant display stand comprises two or more plant trays for displaying potted plants, a display base to support the two or more plant trays, a conduit system interconnecting the two or more plant trays, a draining restrictor for controlling the level of water within the two or more plant trays, and a draining adaptor positioned within one of the plant trays for receiving the draining restrictor.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1a is a perspective view of a potted plant display stand system with a single plant tray, according to one embodiment of the present invention;

FIG. 1b is a perspective view of a potted plant display stand system with two plant trays, according to one embodiment of the present invention;

FIG. 2 is a perspective view of a plant tray used in a potted plant display stand system, according to one embodiment of the present invention;

FIG. 3 is a magnified view of the underside of a plant tray, according to one embodiment of the present invention;

FIG. 4 is a cross-sectional view of the drain plug fitting within the bore of the plant tray, according to one embodiment of the present invention;

FIG. 5 is a perspective view of various plant trays used in the potted plant display stand system, according to one embodiment of the present invention;

FIG. 6a is a perspective view of a display base, according to one embodiment of the present invention;

FIG. 6b is a perspective view of a reinforced display base, according to one embodiment of the present invention;

FIG. 7a is a cross-sectional view of a cross beam member bolted onto a display base, according to one embodiment of the present invention;

FIG. 7b is a magnified view of a display base, according to one embodiment of the present invention;

FIG. 8a is a perspective view of a corner display base, according to one embodiment of the present invention;

FIG. 8b is a perspective view of a large corner display base, according to one embodiment of the present invention;

FIG. 9a is a perspective view of a plant tray mounted onto a display base, according to one embodiment of the present invention;

FIG. 9b is a cross-sectional view of a plant tray and locating pins, according to one embodiment of the present invention;

FIG. 10 is a perspective view of a conduit system, according to one embodiment of the present invention;

FIG. 11 is a magnified cross-sectional view of a potted plant display system, according to one embodiment of the present invention;

FIG. 12 is a magnified cross-sectional view of a plant tray containing a draining adaptor, according to one embodiment of the present invention;

FIG. 13a is perspective view of a drain restrictor, according to one embodiment of the present invention;

FIG. 13b is a magnified view of a drain restrictor set within the drain pipe, according to one embodiment of the present invention;

FIG. 14a is a perspective view of a linearly coupled display base, according to one embodiment of the present invention;

FIG. 14b is a perspective view of a parallel coupled display base, according to one embodiment of the present invention;

FIG. 15a is a perspective view of circular display base, according to one embodiment of the present invention;

FIG. 15b is a perspective view of a two tier half circle display base, according to one embodiment of the present invention;

FIG. 15c is a perspective view of a three tier display base, according to one embodiment of the present invention;

FIG. 16a is a perspective view of a single post vertical display base, according to one embodiment of the present invention;

FIG. 16b is a perspective view of a multi-post vertical display base, according to one embodiment of the present invention;

FIG. 17a is a magnified view of opposing twin slotted brackets fastened onto a single pole vertical display base, according to one embodiment of the present invention;

FIG. 17b is a magnified view of a three twin slotted brackets fastened onto a single pole vertical display base, according to one embodiment of the present invention;

FIG. 17c is a magnified view of a four twin slotted brackets fastened onto a single pole vertical display base, according to one embodiment of the present invention;

FIG. 18a is a perspective view of plant tray positioned onto the twin slotted brackets, according to one embodiment of the present invention;

FIG. 18b is a perspective view of a single post vertical potted plant display stand, according to one embodiment of the present invention;

FIG. 19a is a perspective view of a one sided, three tier, round potted plant display system, according to one embodiment of the present invention;

FIG. 19b is a perspective view of a four sided, three tier, round potted plant display system, according to one embodiment of the present invention;

FIG. 20 is a perspective view of a one sided, three tier, potted plant display system with optional plant hanging attachment, according to one embodiment of the present invention;

FIG. 21a is a perspective view of the potted plant display system placed on cement blocks, according to one embodiment of the present invention;

FIG. 21b is a perspective view of the potted plant display system placed on a wooden display base, according to one embodiment of the present invention;

FIG. 22 is a perspective view of the plant tray rack, according to one embodiment of the present invention;

FIG. 23 is a perspective view of the plant trays fitted onto the plant tray rack, according to one embodiment of the present invention; and,

FIG. 24 is a perspective view of the potted plant transport system, according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

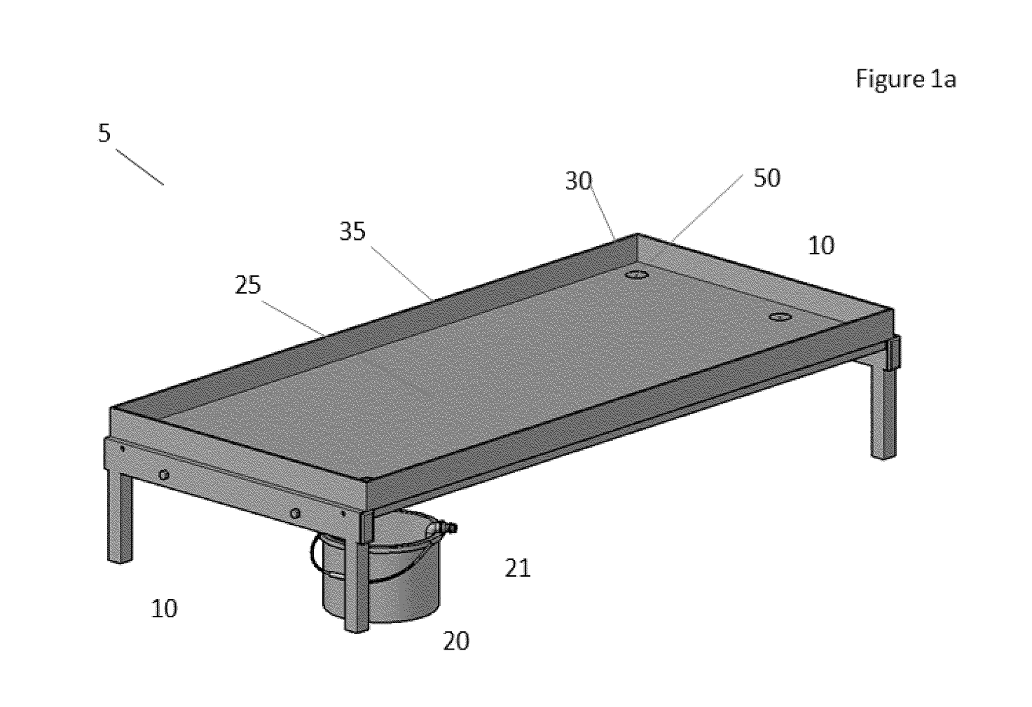

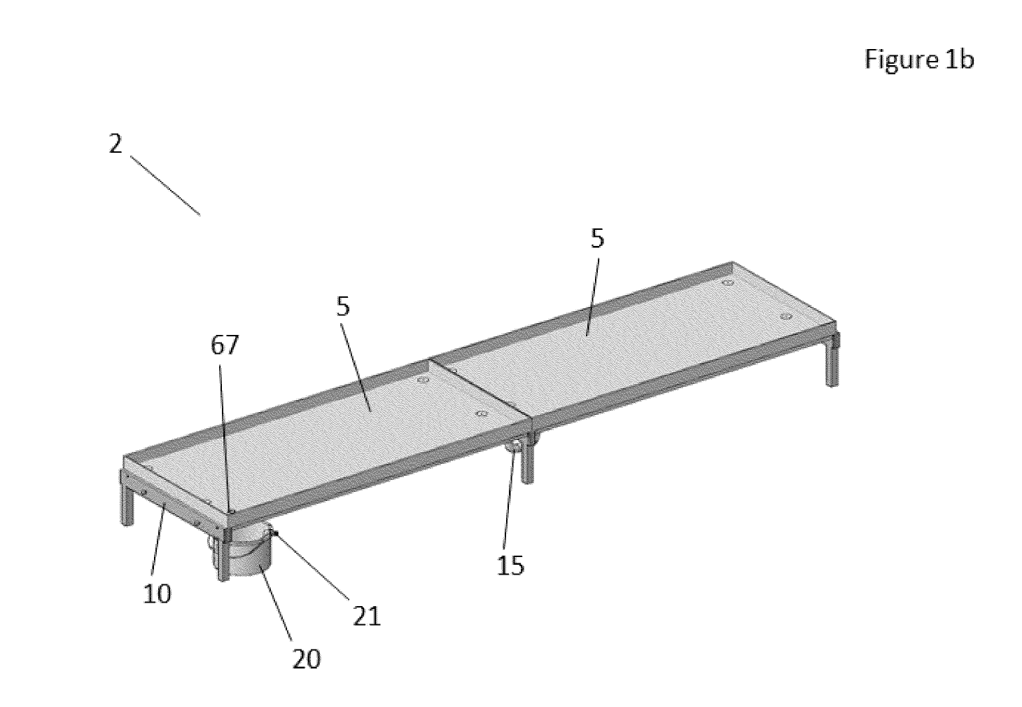

With reference to FIG. 1a and according to one embodiment of the present invention, a potted plant display stand is shown. The potted display stand is composed of a single plant tray 5 with a display base 10. The display base 10 can have numerous configurations and can also be composed of simple elements such as brick for example allowing to raise the plant tray 5.

With further reference to FIG. 1a, the plant tray 5 has a platform 25 which contains multiple bores 30 and is framed with extended upright walls 35. The location of each bore 30 within a plant tray 5 permits interconnectivity between multiple plant trays (not shown). The upright walls 35 contain the water (not shown) within the plant tray 5. An upper lip 40 is formed as the platform 25, along with the walls 35 protrude past the plant tray. The bores 30 can be closed through the use of drain plugs 50. Water from the trays could be drained to drain gutter in the floor if close to the stand through a hose connected to the drain adaptor. If drain is not available than a water bucket 20 can be used as shown. The water bucket 20 is positioned under a bore (not shown) containing a draining restrictor (not shown). The bucket 20 is connected to a suction pump by a hose through a quick attach connector 21 during draining Other features of the plant tray 5 are described below for a potted plant display stand having two plant trays and can be found in a single plant tray.

With reference to FIG. 1b and according to one embodiment of the present invention a potted plant display stand system 2 is shown. The potted plant display stand system 2 is primarily comprised of plant trays 5, display base 10, and a conduit system 15. The potted plant display stand system 2 as illustrated comprises two plant trays 5. The adaptability of the potted plant display stand system 2 allows a user to adjust the amount of trays that the system contains. Additional trays 5 can be added horizontally or vertically, through a tiered system. Potted plants (not shown) are placed on the surface of the plant tray 5. If the display is more than one level the filling the trays always starts with the top level. Plant trays 5 are filled with water (not shown). Water level within plant trays 5 is dependent upon a draining restrictor 67. A single draining restrictor 67 positioned within a draining adaptor (not shown) can maintain the desired water level of multiple plant trays 5. The potted plants (not shown) are able to take in water from the plant trays 5. As such, watering of potted plants requires the filling of the plant trays 5. A conduit system 15 connects the individual plant trays 5 within the potted plant display stand system 2. The conduit system 15 allows the user to fill multiple plant trays 5 within the potted plant display stand system 2 by pouring water (not shown) into a single tray 5. After all the trays in the display stand have been filled with water, water should be left in the trays for several hours or overnight to let the soil in the flowerpots absorb the water. If necessary water from the trays could be drained afterwards. Water from the trays could be drained to drain gutter in the floor if close to the stand through a hose connected to the drain adaptor. If drain is not available than a water bucket 20 can be used as shown. The water bucket 20 is positioned under bore (not shown) containing the draining restrictor 67. The bucket 20 is connected to a suction pump by a hose through a quick attach connector 21 during draining The suction pump could be a Ventury tube, as used in aquarium industry or an electric pump. There is a pipe that connects quick-attach connector 21 to the bottom of the bucket. Before starting draining the suction pump must be turned on. The draining restrictor is removed from the bottom tier and water is running into drain or into a bucket 20. It is being sucked from the bucket to the drain. The bucket 20 does not have the capacity to capture all the water within the potted plant display system 2 if the display is multi tier than draining is started by removing draining restrictor from the bottom tier. Once the bottom tier is emptied the draining restrictor is removed from the tray above. Draining has to be done in succession not to overwhelm the draining and cause a water spill.

The potted plant display stand system 2 provides an effective manner for business and home owners to take care of and display potted plants. Potted plants are displayed on the potted plant display stand system 2 in various customizable configurations. Watering of multiple potted plants is simplified when placed on the potted plant display stand system 2. Pots carrying the potted plants generally contain multiple apertures at the base of the pot. When placed onto the plant tray 5, the apertures at the base of the pot allow water to penetrate into the pot, be absorbed by the soil, and be subsequently absorbed by the roots of the plant. The conduit system 15 allows equal distribution of water between the plat trays 5 within the potted plant display stand system 2. Thereby, the conduit system 15 allows the business or home owner to water the entire potted plant display stand system 2 by filling a single plant tray 5.

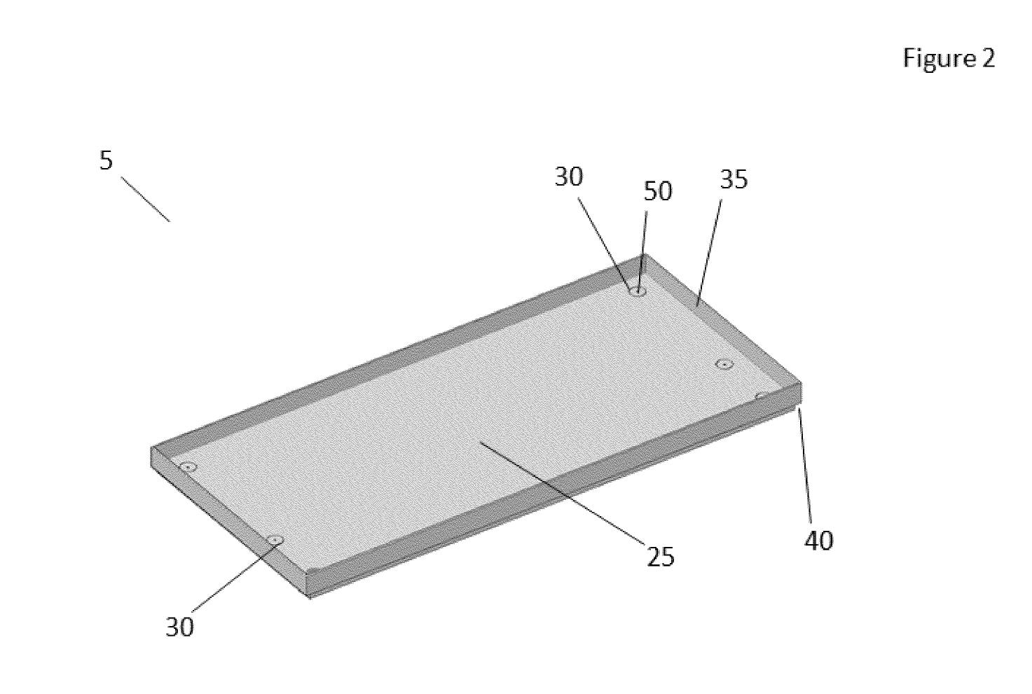

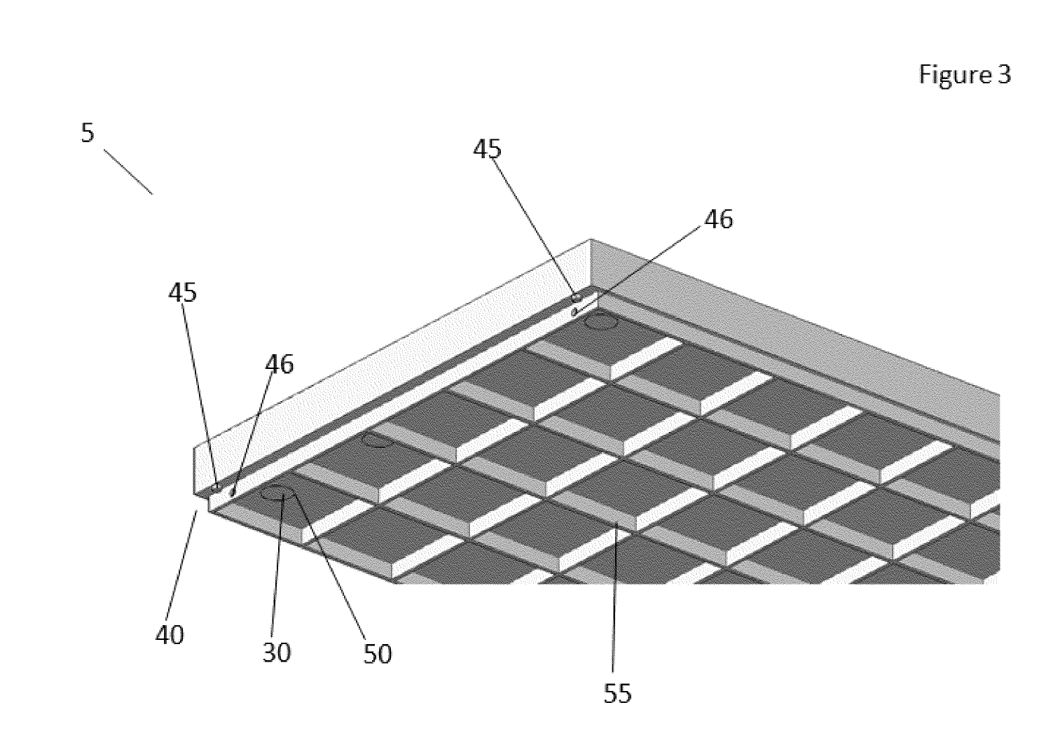

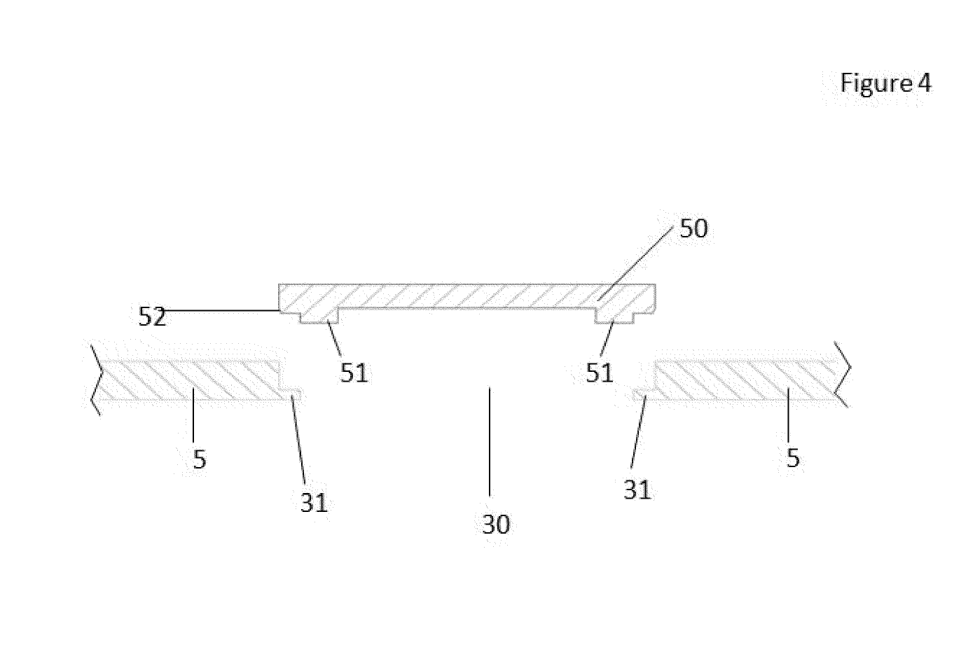

With reference to FIGS. 2, 3, and 4 and according to one embodiment of the present invention the plant tray 5 is shown in detail. The plant tray 5 is constructed from moulded hard plastic. The hard plastic confers strength, rigidity and water retaining properties to the plant tray 5. A worker skilled in the relevant art would appreciate the various materials that could be used to form the plant tray 5. The plant tray platform 25 contains multiple bores 30 and is framed with extended upright walls 35. The location of each bore 30 within plant tray 5 permits interconnectivity between multiple plant trays 5. The upright walls 35 contain the water (not shown) within the plant tray 5. An upper lip 40 is formed as the platform 25, along with the walls 35 protrude past the plant tray base. With specific reference to FIG. 3, the underside of the plant tray 5 is shown in detail. The bottom of the tray 55 is reinforced in order to withstand significant loads. Each corner of the plant tray 5 contains locating pins 45 on the underside of the upper lip 40. The corners of the plant tray base contain a locking hole 46. The platform bores 30 are sealed with drain plugs 50. With specific reference to FIG. 4, the sealing mechanism of the platform bore 30 is shown in greater detail. A cross-sectional view of the drain plug 50 as it seals the bore 30 is shown in FIG. 4. The rim 51 of the drain plug 50 interacts with the lower lip 31 of the bore 30. A water tight seal is formed by press fitting the rounded edges 52 of the drain plug 50 onto the bore 30. Other mechanisms of forming a water tight seal include the use of a rubber ring (not shown) on the rim 51 of the drain plug 50. A worker skilled in the relevant art would appreciate the various watertight methods that can be employed to seal the drain plug 50 onto the bore 30.

With reference to FIG. 5 and according to one embodiment of the present invention, additional shapes of plant trays are shown in greater detail. Plant trays illustrated include: square 6; half circular 7; corner circular 8; and, oval 9. With these shapes most display stands could be built.

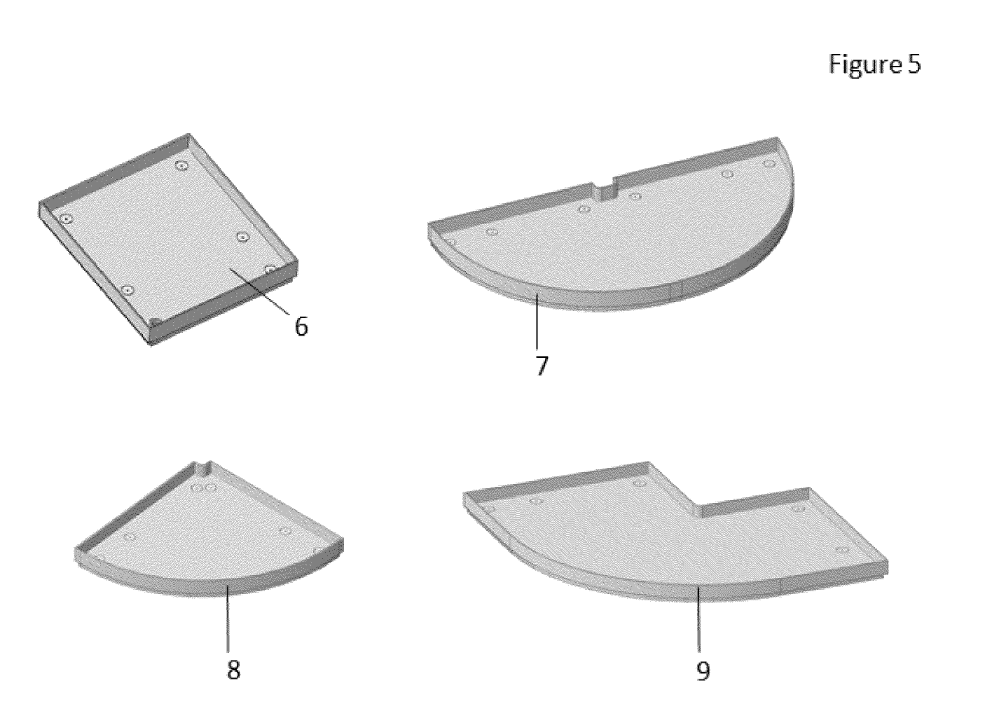

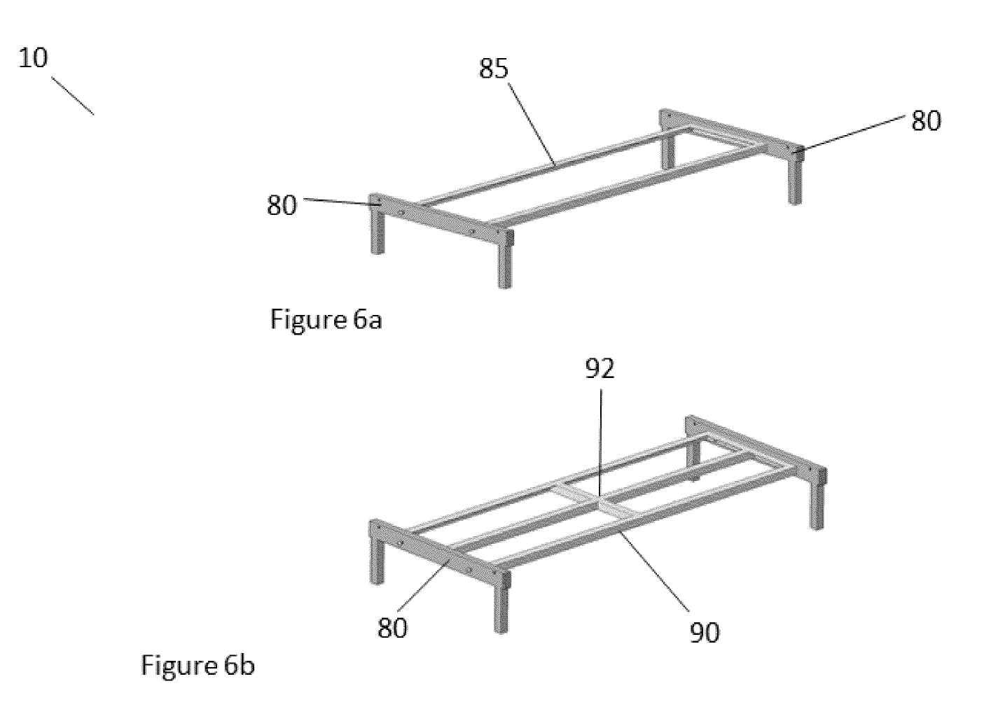

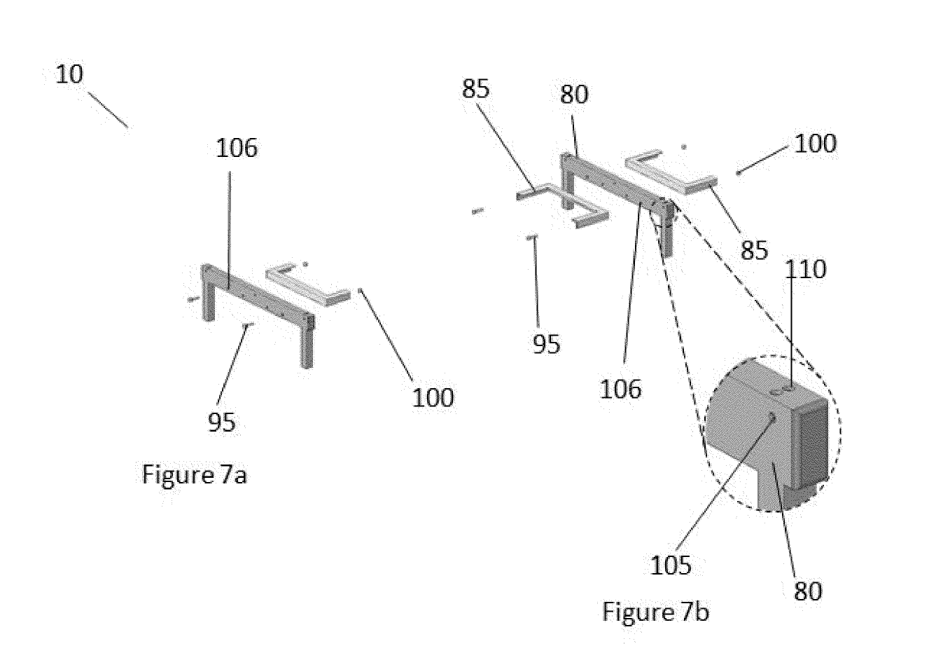

With reference to FIGS. 6 and 7 and according to one embodiment of the present invention, a display base 10 is shown. The display base 10 is comprised of pedestal legs 80 and cross beam member 85. The cross beam member 85 is positioned between the pedestal legs 80 thereby maintaining the upright positioning of each pedestal leg 80. Additionally, the cross beam member 85 restricts bending and flexing of the display base 10. In a tiered potted plant display system, the lower tier is often used as a step by individuals reaching for higher tiers. As such, the lower tier is required to withstand the weight of a person. The lower tier display base 10 contains a reinforced cross beam member 90 that prevents display base 10 bending as a result from supporting the additional weight. With specific reference to FIG. 6b, a reinforced display base 10 is shown. A reinforced cross beam member 90 contains support beams 92. The support beams 92 in FIG. 6b are illustrated as a cross structure. A worker skilled in the relevant art would appreciate the various shapes of the support beam 92 that is able to reinforce the display base 10. With specific reference to FIG. 7, the construction of the display base 10 is shown in greater detail. A cross-section of the cross beam member 85 is shown to illustrate attachment mechanism. A Nut 100 and bolt 95 system is used to attach the cross beam member 85 to the pedestal legs 80. The bolt 95 penetrates the pedestal legs 80 through the frame holes 106, then penetrates the crossbeam member 80 and is secured within the display base 10 by a nut 100. A worker skilled in the relevant art would appreciate the various attachment mechanisms that can be used to construct the display base 10. Based on the nut 100 and bolt 95 attachment system numerous display bases can be attached in succession. With specific reference to FIG. 7b a magnified view of the corner region of the pedestal leg 80 is shown. The upper surface of the pedestal leg 80 contains apertures 110. The apertures 110 mate with the locating pins of the plant tray (not shown) which in turn positions the plant tray (not shown) onto the display base 10. Two adjacent apertures 110 permits two trays (not shown) to be positioned on a single pedestal leg. Once positioned, the plant tray locking holes (not shown) align with the affixing holes 105.

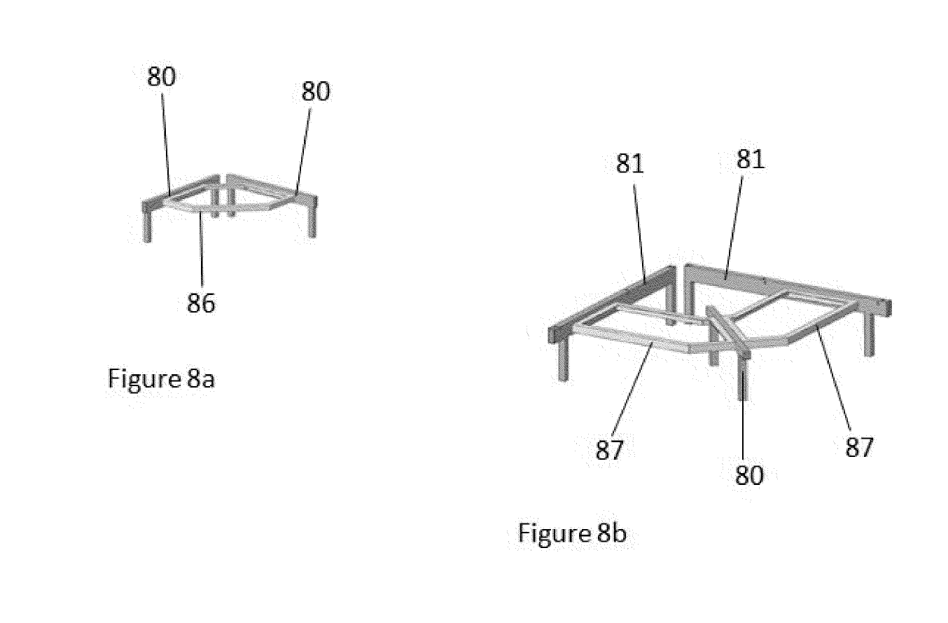

With reference to FIGS. 8a and 8b and according to one embodiment of the present invention the various alternative display base shapes 10 are shown. Through the use of various support beam members 85, various display base 10 shapes can be constructed. Illustrated in FIG. 8 are display base corners of varying sizes. The shape of the corner support beam 86, when attached to the pedestal legs 80, positions the pedestal legs 80 in a perpendicular fashion, thereby forming a small corner display base. With specific reference to FIG. 8b a large corner display base is shown. Large corner display base 10 is primarily comprised of an extended pedestal legs 81, angled support beam 87, and pedestal leg 80. The extended pedestal legs 81 form the outer corner of the display base 10. The pedestal leg 80 is attached between the angled support beams 87 to reinforce the structure. The various shapes of the display base 10 correspond to the alternate plant trays 5.

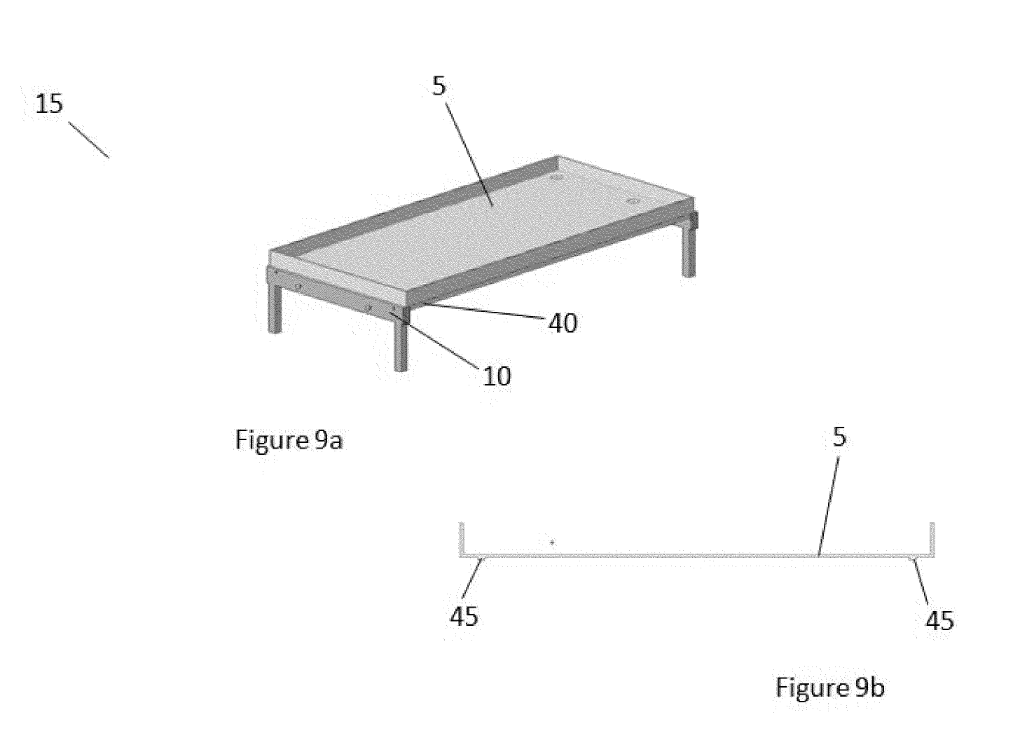

With reference to FIGS. 9a and 9b and according to one embodiment of the present invention the plant tray 5 is shown mounted onto the display base 10. The display base 10 is set within the upper lip 40 of the plant tray 5. With specific reference to FIG. 9b a cross-sectional view of the upper lip 40 is shown. The locating pins 45 on the underside of the upper lip 40 mate with the display base 10 apertures 110 (not shown) thereby fixing the position of the plant tray 5. A bolt (not shown), or any other rod shaped device, is placed through the locking holes (not shown) of the plant tray 5 and the affixing holes (not shown) of the display base 10. Other rod shaped devices include, but not limited to a pin and a nail. The bolt (not shown) connects the plant tray 5 onto the display base 10, thereby preventing any accidental separation of the plant tray 5 from the display base 10.

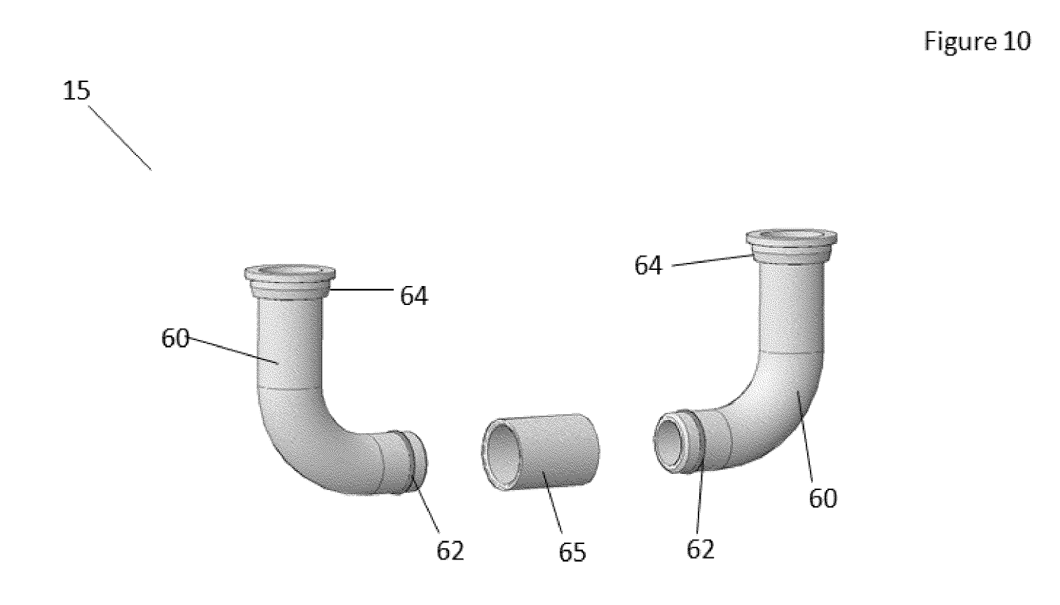

With reference to FIG. 10 and according to one embodiment of the present invention the conduit system 15 is shown. The conduit system 15 is primarily comprised of elbow joints 60, and a linking member 65. The elbow joints 60 are interconnected through the use of the linking member 65. A rubber ring 62 at the connection point between the elbow joint 60 and the linking member 65 creates a water tight seal. A worker skilled in the relevant art would appreciate the various methods for creating a water tight seal between the elbow joint 60 and the linking member 65. The protruding shoulder 64 is located at the upper most region on the elbow joint 60.

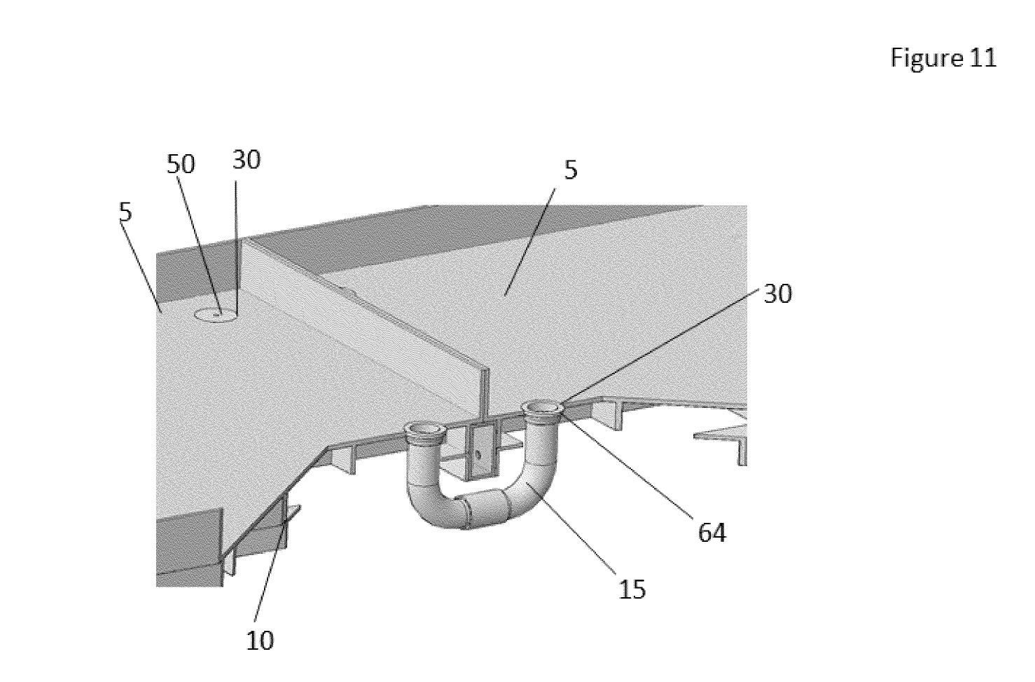

With reference to FIG. 11 according to one embodiment of the present invention a magnified cross-sectional view of adjoining plant trays 5 are shown with the conduit system 15. The conduit system 15 connects 2 adjacent plant trays 5 within the potted plant display system 2. The protruding shoulder 64 interacts with bore's 30 lower lip 31 (not shown). Location of the bores 30 within the plant tray 5 permits the connection of the conduit system 15 between adjacent plant trays 5. To fill the trays, a user is required to add a water source to one of the connected trays. Water (not shown) enters plant tray 5 where it subsequently passes through the conduit system 15 and enters the connecting plant tray 5. Upon passing through all of the trays within the potted plant display system 2 (not shown), the water reaches equilibrium and begins to fill the connected trays.

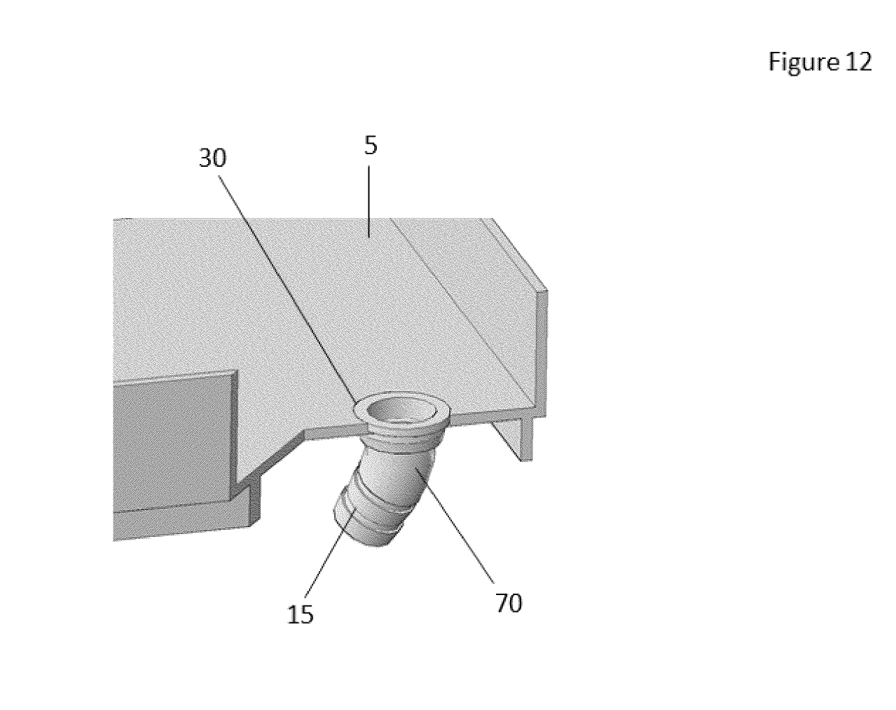

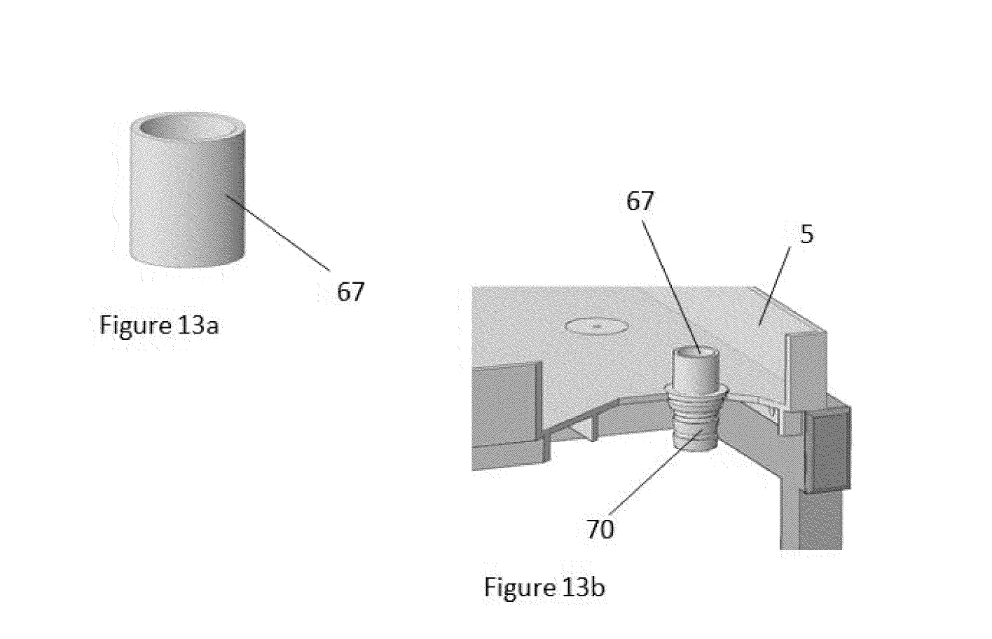

With specific reference to FIG. 12 a cross-sectional view of a plant tray 5 corner containing a draining adaptor 70 within bore 30. With reference to FIGS. 13a and 13b and according to one embodiment of the present invention the drain restrictor 67 is shown.

With specific reference to FIG. 13b, a cross-sectional view of a plant tray 5 is shown containing the draining adaptor 70 and the drain restrictor 67. The drain restrictor 67 is a hollow cylinder that is set within the cavity of the draining adaptor 70. A water tight seal is formed between drain restrictor 67 and the inner rim of the draining adaptor 70. The drain restrictor 67 is press fitted onto the draining adaptor 70, thereby forming a water tight seal. Additionally, a water tight seal can be formed if the drain restrictor 67 is threaded onto the draining adaptor 70. A worker skilled in the relevant art would appreciate the various water tight setting methods that could be used to attach the drain restrictor 67 to the draining adaptor 70. Once press fitted onto the draining adaptor 70, the drain restrictor allows plant tray 5 to be filled with water (not shown). The depth of the water within plant tray 5 is dependent on the use set length of the draining restrictor 67 protruding from the surface of the tray 5. Upon reaching the user selected height, water will enter the draining restrictor 67 and run through the draining adaptor. A single draining restrictor 67 is used to set the water level of numerous interconnected plant trays 5 that are located on the same horizontal plane. Interconnectivity by the conduit system (not shown) allows multiple plant trays 5 to contain the same level of water. As such, adjusting the water level in a single plant tray 5 through the use of a draining restrictor 67 will subsequently adjust the water level in the interconnected plant trays 5 that are on the same horizontal plane.

Additionally, the draining adaptor 70 functions during user initiated draining To drain, the draining restrictor (not shown) is extracted from the draining adaptor 70 thereby permitting the water in the tray to run through it into either a floor drain or a bucket. Draining into a bucket requires the additional use of a pump or a suction system (not shown) to remove the water from the bucket and displace it to a remote drain. If the display is multi level than draining starts with draining the bottom level first. Only after the bottom tray or trays are empty than the draining restrictor from the draining adaptor in the tray above is removed and so on. The draining must be done in succession to avoid the spill.

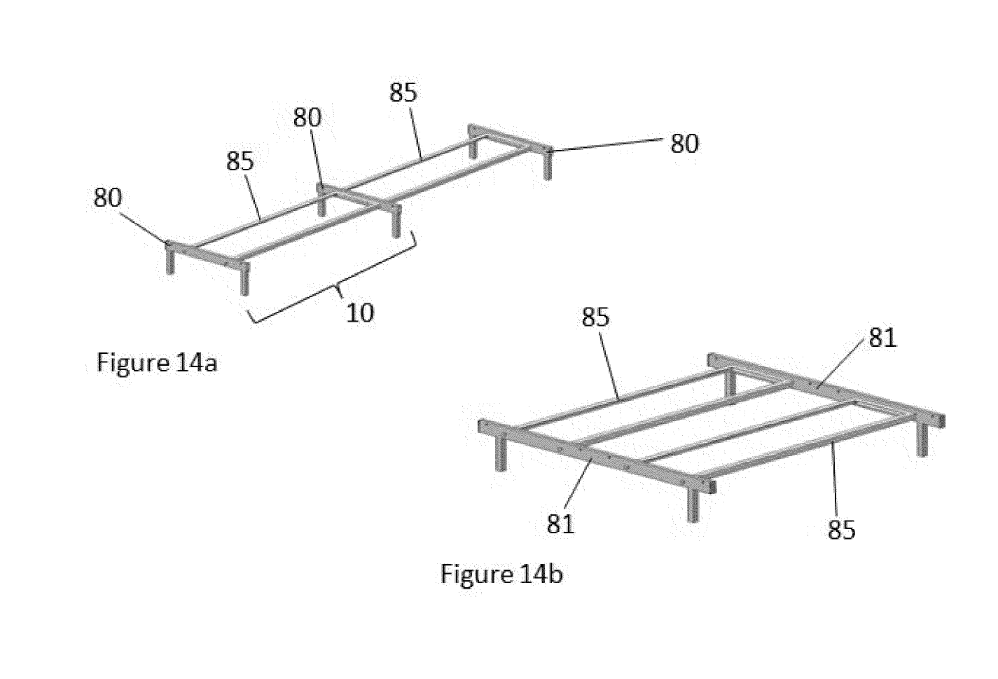

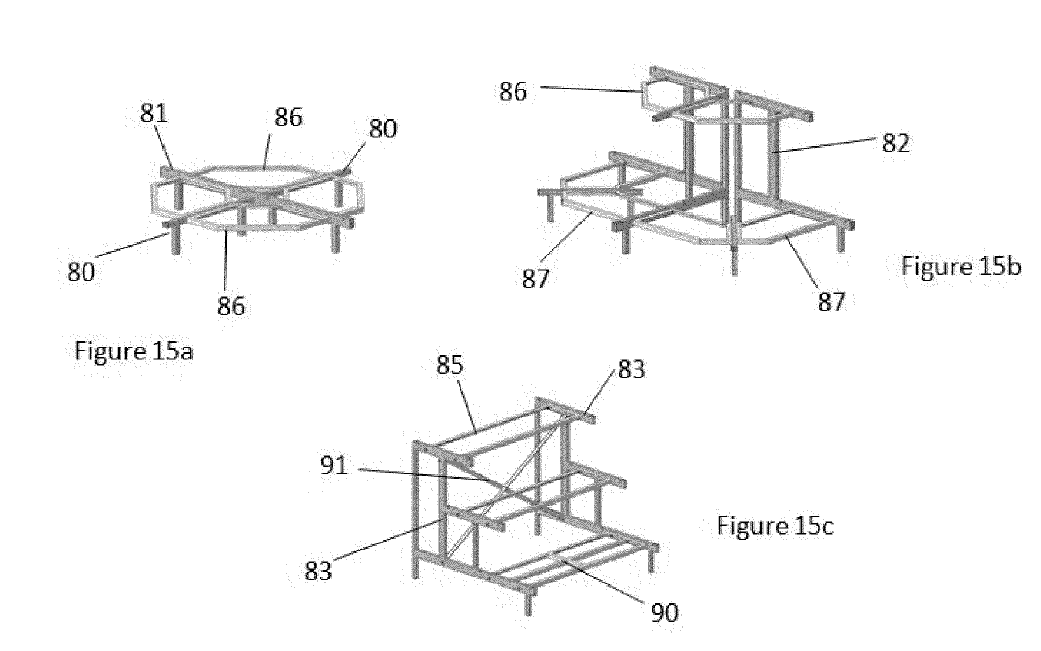

With reference to FIGS. 14 and 15 and according to one embodiment of the present invention the adaptability of the display base 10 is shown. Adaptability is based on the interconnectivity of the individual parts of the display base and based on alternate forms of the pedestal legs 80. With specific reference to FIG. 14a a display base 10 is shown extended in the longitudinal direction. The addition of a support beam member 85 and pedestal leg 80 onto an existing display base 10 extends the display base 10 in the longitude direction. With specific reference to FIG. 14b a display base 10 is shown extended in the latitude direction. A latitudinal extended display base 10 requires the use of extended pedestal legs 81. Extended pedestal legs 81 permit the attachment of multiple support beam members 85. With specific reference to FIG. 15, alternative display base 10 structures are shown. The alternative display structures are constructed from the use of various forms of pedestal legs 80 in conjunction with modified support beam members. With specific reference to FIG. 15a a circular display base 10 is shown. Two pedestal legs 80 connect to the center of an extended pedestal leg 81 forming a cross structure. Multiple corner support beams 86 attach within the cross structure. With specific reference to FIGS. 15b and 15c tiered display bases 10 are shown. Tiered displays are formed through the use of tiered pedestal legs. A worker skilled in the relevant art would appreciate the number of tiers in a tiered display base 10 is dependent on user preference. With specific reference to FIG. 15b, a two tiered display base is shown. The two-tiered display base is shown in the half-circular confirmation. A worker skilled in the relevant art would appreciate that the two-tiered display base can be formed in a number of shapes depending on user preference and the support beam member used within the base. Through the use of three two-tiered pedestal legs 82 in conjunction with two pedestal legs 80 and corner/angled support beams 68/87 forms a two-tiered circular display base. With specific reference to FIG. 15c a three-tiered display base is shown. A three-tiered display base is primarily comprised of three-tiered pedestal legs 83, a reinforcing truss 91, and support beam members 85. Reinforced support beam member 90, is used on the lower tier in order to support a person's weight as they attempt to reach for higher tiers. A worker skilled in the relevant art would appreciate that the three-tiered display base can be formed in a number of shapes depending on user preference.

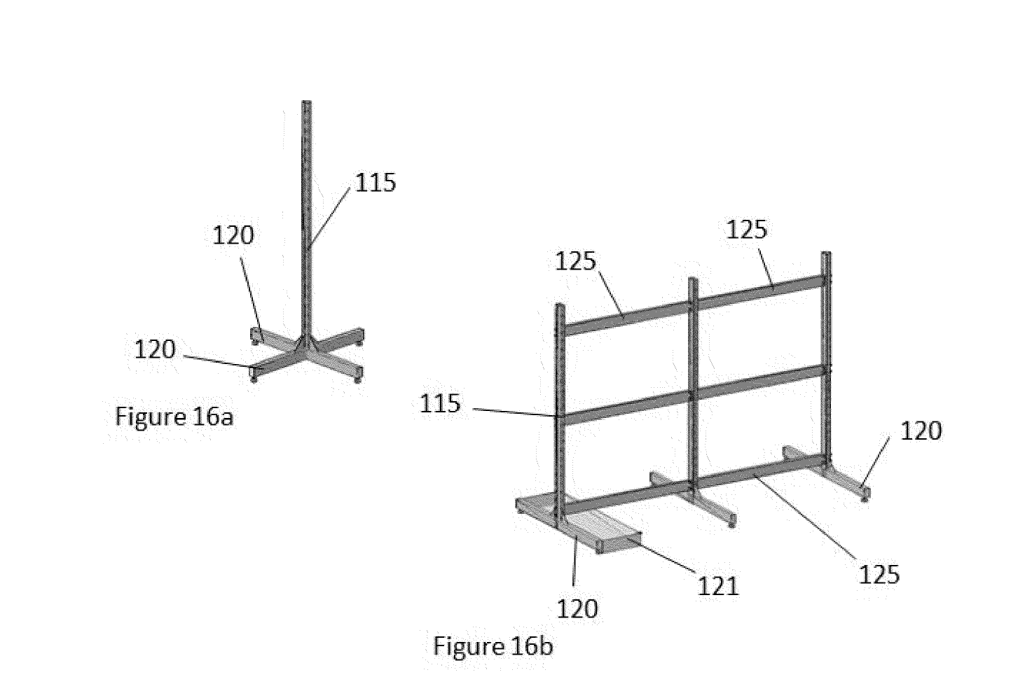

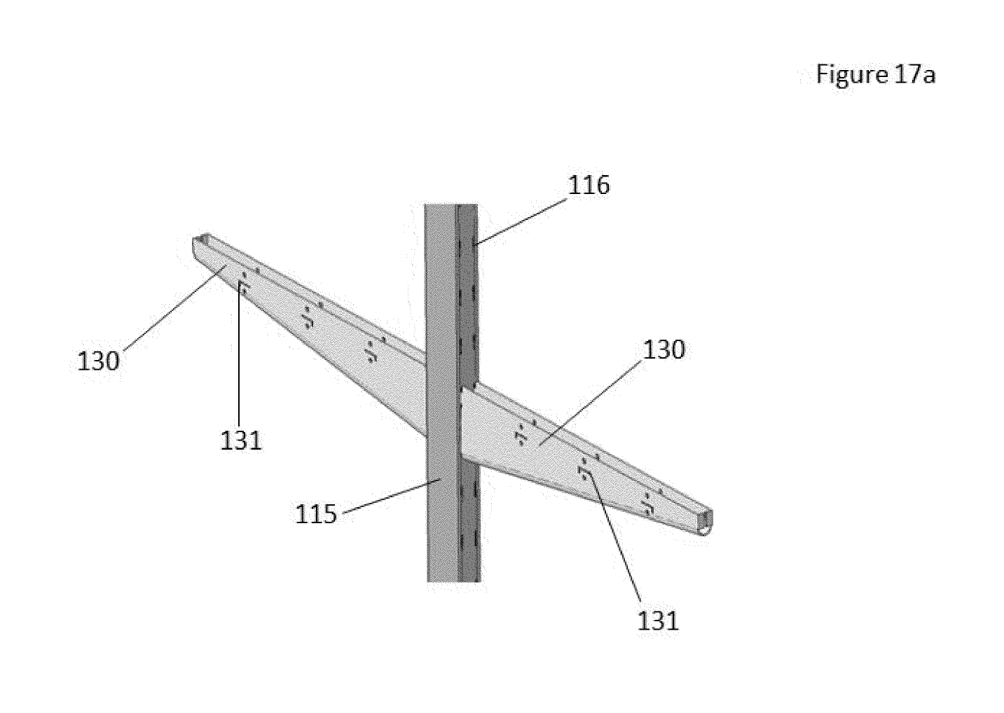

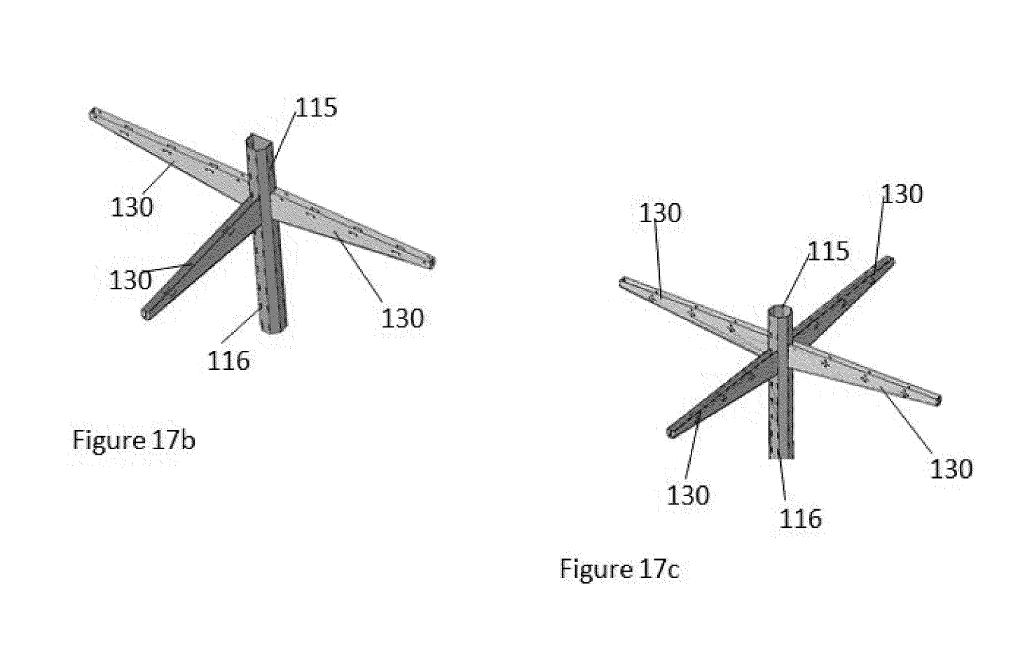

With reference to FIGS. 16 and 17 and according to one embodiment of the present invention, a vertical display base 10 is shown. The vertical display base 10 can be comprised of a single vertical post 115, or multiple interconnected vertical posts 115.

Posts 115 contain a slotted pattern. The length of the platform legs 120 is dependent on the height of the post 115, and the projected weight of the potted plants (not shown) placed onto the vertical display base. A single post vertical display base 10 is shown with four platform legs. A worker skilled in the relevant art would appreciate the various mechanisms that can be employed to maintain the post in an upright position. Other platform mechanisms include, but are not limited to, a round base, affixing onto the floor, and connecting the post to the ceiling. With specific reference to FIG. 16b a vertical base with three posts is shown. A worker skilled in the relevant art would appreciate that a vertical base with multiple posts can have anywhere from two to thirty interconnected posts. The vertical posts 115 are interconnected by rods 125 positioned at the upper and lower region of the vertical posts 115. The rods connect to the vertical posts through a nut and bolt mechanism. A worker skilled in the relevant art would appreciate the various methods of connecting the rods 125 to the vertical posts 115. Posts 115 that are interconnected in a multiple pillar vertical display base require two platform legs 120 positioned perpendicular to the display base plane. A modified water bucket 121 is fits underneath the lower rod 125. With specific reference to FIGS. 17a-17c the bracket 130 is shown connected to a vertical post 115. The bracket 130 is a twin slotted, triangularly shaped folded steel. A worker skilled in the relevant art would appreciate the various materials that can be used to construct bracket 130. The bracket 130 contains twin hooks (not shown), that when inserted into twin slotted ports 116 of the posts 115, connect the bracket 130 to the post 115. Each plane of bracket 130 contains a series of L-shaped apertures 131. A bracket 130 can be connected to two, three, and four sides of a vertical post. As illustrated in FIGS. 17b and 17c, three and four brackets 130 can connect onto the twin slotted post 115, respectively.

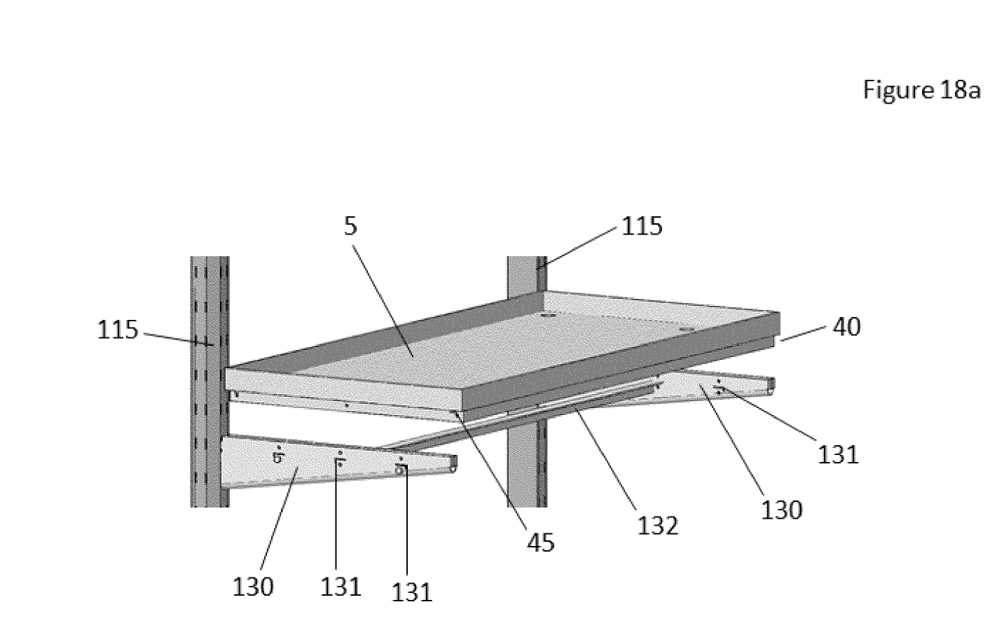

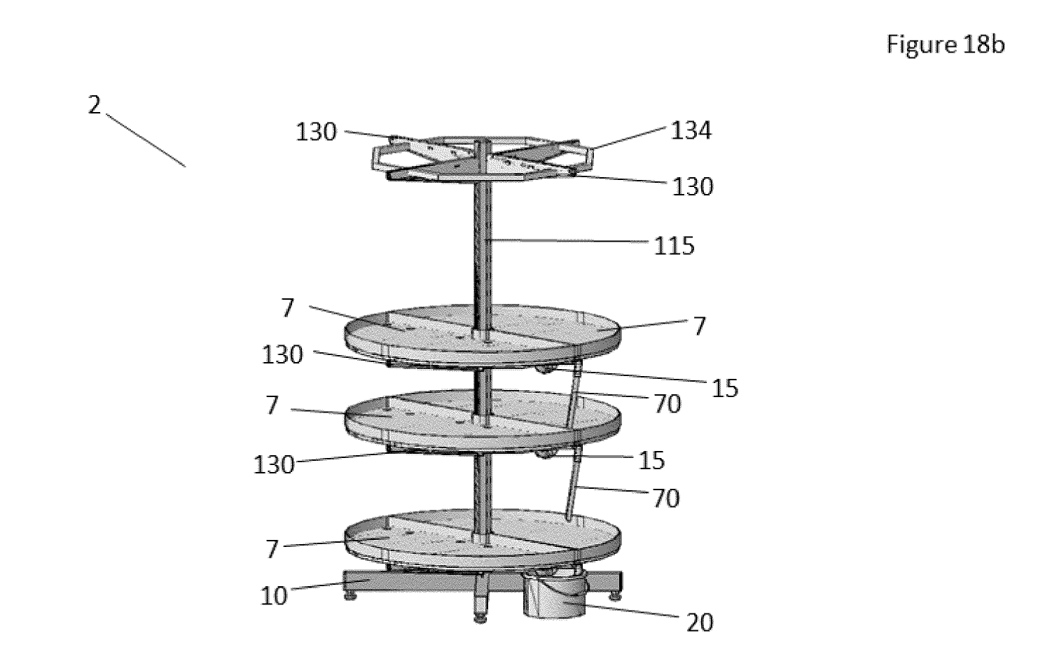

With reference to FIG. 18a and according to one embodiment of the present invention the plant tray 5 is positioned for mounting onto the bracket 130. The illustrated plant tray 5 mounts between two posts 115 within a multiple post display base 10. The bracket 130 on each post 115 interacts with the upper lip 40 of the plant tray 5. Each fold of the bracket 130 interacts with a single plant tray 5, thereby allowing one bracket 130 to interact with 2 adjacent plant trays 5. The locating pins 45 secure the plant tray 5 into position by fitting within the cavity of the bracket 130. A worker skilled in the relevant art would appreciate the various securing methods available to secure the plant tray 5 onto the brackets 130. Other securing methods include, but are not limited to screws, electric ties, rivets, and glue. To support heavier loads placed onto the plant tray 5, an L-shaped reinforcing beam 132 can be fitted between adjacent brackets 130. The L-shaped reinforcing beam 132 is connected to bracket 130 by fitting within the L-shaped apertures 131. As many as three L-shaped reinforcing beams 132 can be fitted between adjacent brackets 130.

With reference to FIG. 18b and according to one embodiment of the present invention a single post vertical potted plant display stand 2 is shown. A single post vertical potted plant display stand 2 is primarily comprised of a single post 115 within a vertical display base 10, half circular potted plant trays 7, hanging plant attachment 134, conduit system 15, draining adapter 70 and a draining device, such as a bucket 20. Each half circular potted plant tray 7 is set around the post 115 by connecting onto a bracket 130. The half circular potted plant trays 7 located on the same tier are connected by the conduit system 15. The positioning of the half circular potted plant tray 7 along the post is dependent on location of a connection point between the bracket 130 and the post 115. A draining adaptor 70 connects the upper tier circular potted plant tray 7 with a lower tier circular potted plant tray 7 located directly below. The circular plant tray 7 on the bottom tier connects to a draining device, such as a bucket 20. A hanging plant attachment 135 is attached to the post 115 by connecting onto four brackets 130. The four brackets 130 act as a support member for the hanging plant attachment 134.

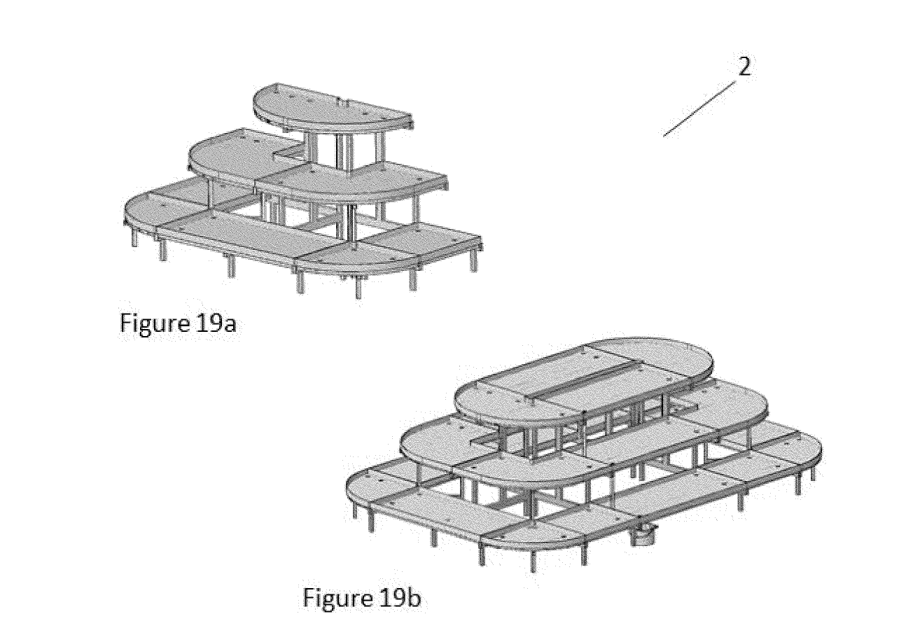

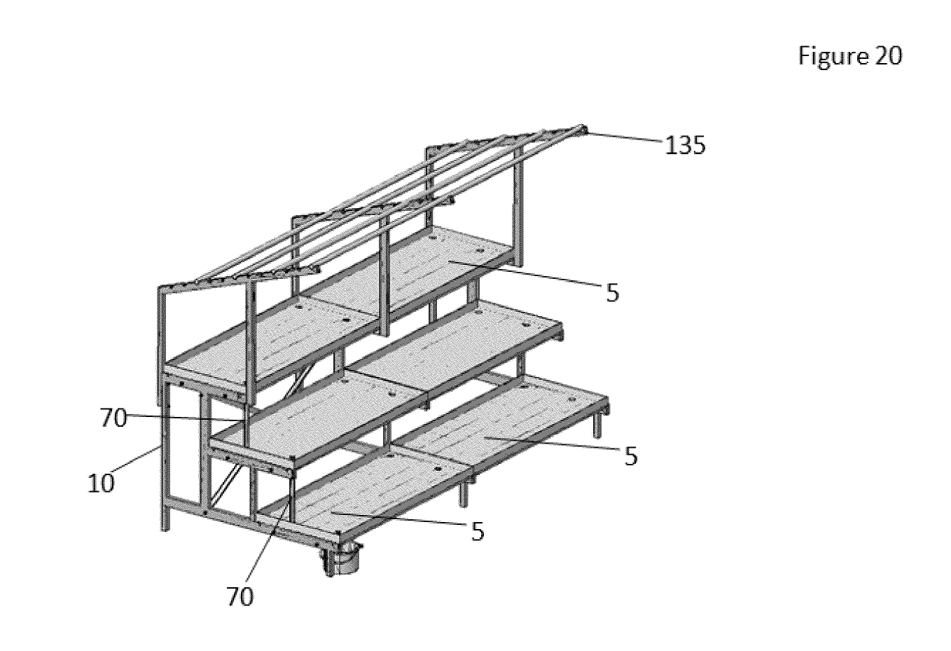

With reference to FIG. 19 and according to one embodiment of the present invention a rounded three tiered potted plant display system 2 is shown. Adaptability of the system allows the user to adjust the system to a desired size. A half circle three tiered potted plant display system 2 is ideal for potted plant display in smaller areas, in some embodiments placed against a wall. The potted plant display system 2 can be modified and adapted to fit a larger area by converting it into an island. With specific reference to FIG. 19b, an island potted plant display system 2 is shown.

With reference to FIG. 20 and according to one embodiment of the present invention a hanging plant attachment 135 secured onto a three tiered potted plant display system 2 is shown. The hanging plant attachment 135 is secured onto the three tiered display base 10. The hanging plant attachment 135 does not interfere with the plant trays 5. The hanging plant attachment 135 is secured onto the three tiered display base 10 through the use of nuts and bolts. A worker skilled in the relevant art would appreciate the various securing methods that can be employed to secure the hanging plant attachment 135 onto a three tiered potted plant display system 2. A draining adaptor 70 connects the upper tier plant trays 7 with the lower tier plant tray 7. The hanging flowerpots can be watered manually using a watering hose and trays 5 underneath will catch any spilled water.

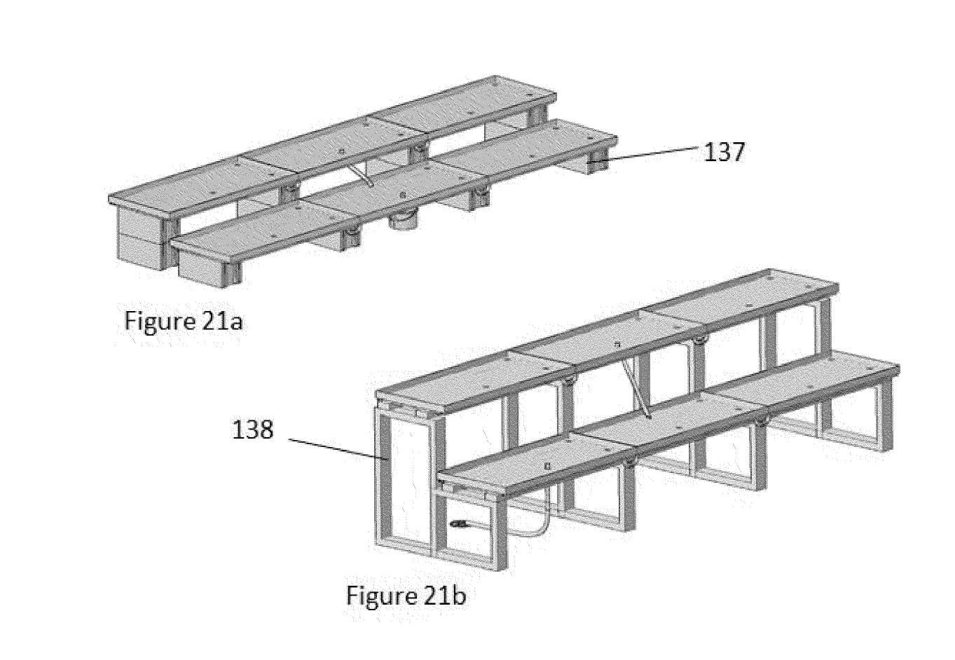

With reference to FIG. 21 and according to one embodiment of the present invention a potted plant display system 2 is shown without the use of the display base. A potted plant display system can be comprised of plant trays 5, conduit system 15, and a user constructed base. The base can be constructed from cement blocks 137, as illustrated in FIG. 21a, or constructed from wood 138, as illustrated in FIG. 21b.

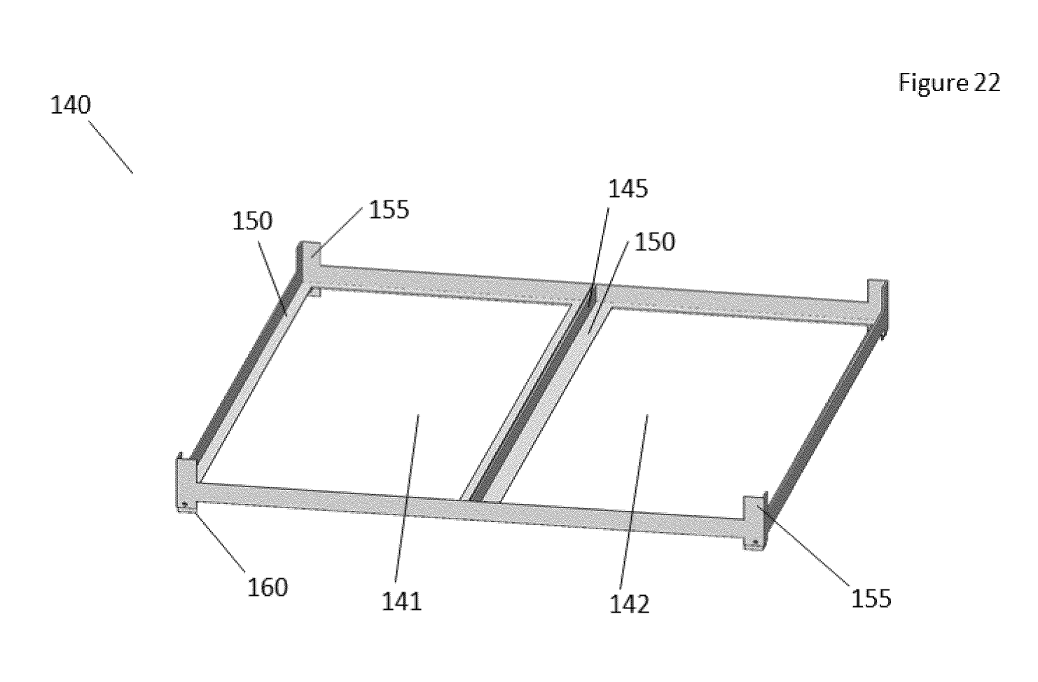

With reference to FIG. 22 and according to one embodiment of the present invention a plant tray rack 140 is shown. The plant tray rack 140 is comprised of a metal frame that is horizontally divided by a truss 145. The truss 145 divides the plant tray rack 140 into two equal sections, 141 and 142. A lower lip 150 extension adorns the lower region of sections 141 and 142. The corners of the plant tray rack 140 contain an upper 155 and lower 160 extensions. The lower extension contains a depression. Plant tray racks 140 can be stacked one on top of the other. The lower extension 160 is depressed to correspondingly fit within the upper extension 155 of another plant tray rack 140.

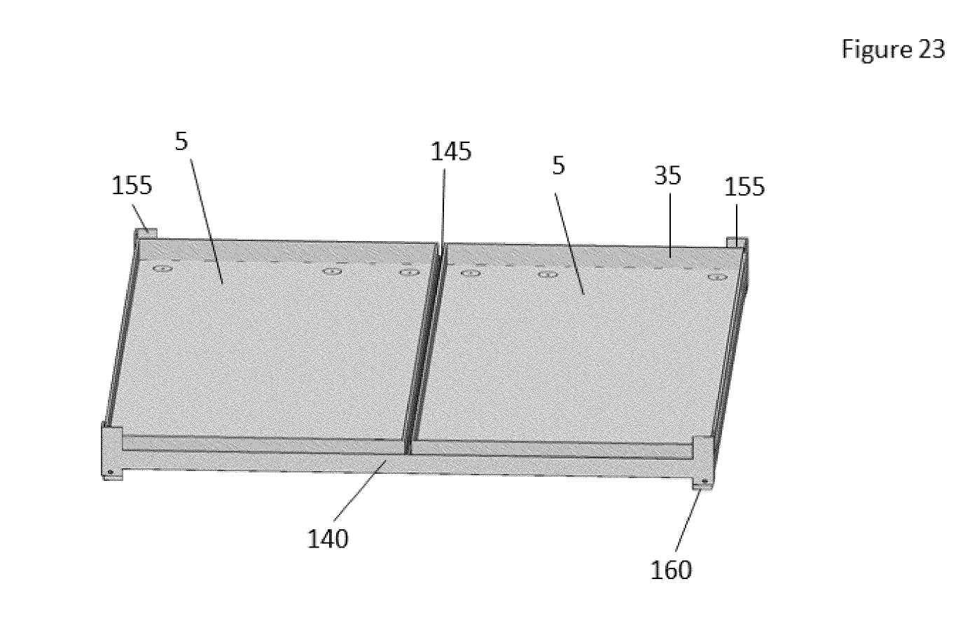

With reference to FIG. 23 and according to one embodiment of the present invention plant trays 5 are shown fitted onto the plant tray rack 140. Two plant trays 5 fit within the frame of the plant tray rack 140. The truss 145 of the plant tray rack 140 supports the inner region of the plant trays 5. The lower lip (not shown) of the plant tray rack 140 interacts with the upper lip (not shown) of the plant tray 5. The upper extension 155 of the plant tray rack 140 extend past the upright walls 35 of the plant tray 5, thereby ensuring that the plant tray racks 140 can stack one on top of the other while supporting the plant trays 5.

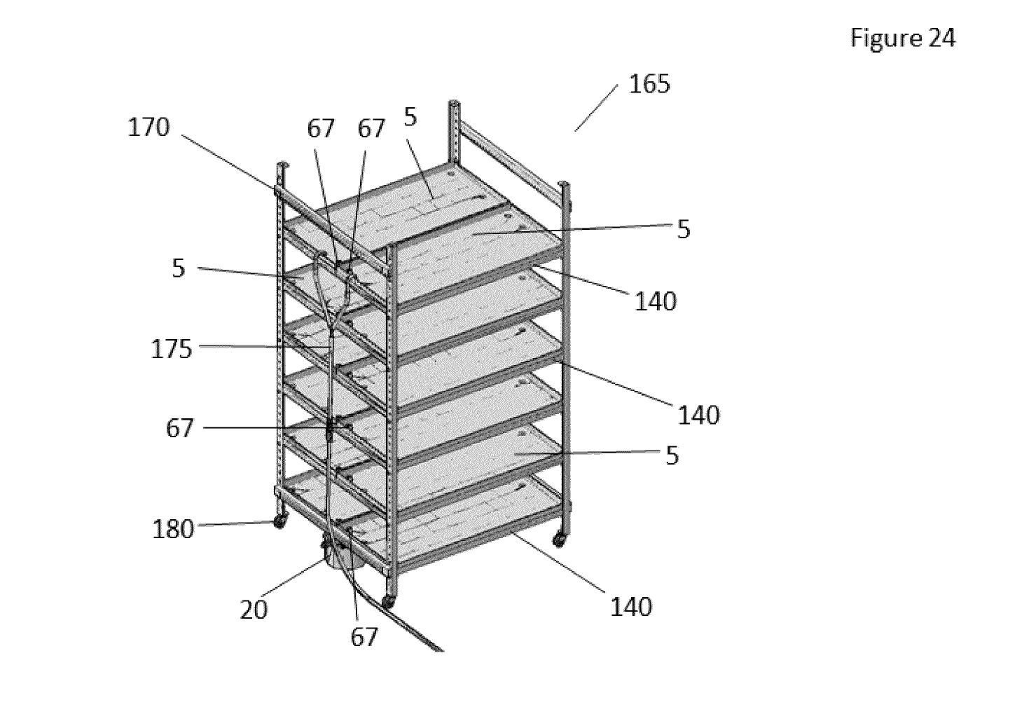

With reference to FIG. 24 and according to one embodiment of the present invention the potted plant transport system 165 is shown. The potted plant transport system 165 is primarily comprised of a transport shell 180, plant tray racks 140, plant trays 5, and a water delivery system 175. Plant tray racks 140 fitted with plant trays 5 are connected to the transport shell 180. The connection points along the transport shell 180 vary depending on size of potted plant (not shown) required for transport. The plant tray racks 140 are connected to the transport shell 180 by four screws. A worker skilled in the relevant art would appreciate the various connecting methods that can be employed to attach the plant tray racks 140 to the transport shell 180. The water delivery system 175, comprised of a Y shaped hose, connects a water source to the plant trays 5 on the uppermost plant tray rack 140. The hose is Y shaped in order to fill the top trays 5 independently. A water source can originate from the tap, or from a portable water tank. A worker skilled in the relevant art would appreciate the various sources of water that can be employed by the water delivery system 175. Water is passed onto the plant trays 5 located on the uppermost plant tray rack 140. Draining restrictor 67 is fitted onto the draining adaptor (not shown) on every plant tray 5 within the potted plant transport system 165. The draining restrictor 67 maintains the water level within each plant tray 5. Once the top trays 5 have been filled, water is passed through the draining restrictor 67 and passed onto the subsequent plant tray 5 located directly below. The relay of water is continued until all plant trays 5 within the potted plant transport system 165 have been filled. Any excess water is drained into the water bucket 20. Mobility of the potted plant transport system 165 is made possible by coasters 180. A worker skilled in the relevant art would appreciate the various mechanisms that can be employed to increase the mobility of the potted plant transport system 165. Upon delivery of the potted plants (not shown), the potted plant transport system 165 can be used by the retailer as a display stand.

1. A plant tray for displaying potted house plants comprising:
a) a bore positioned in the plant tray for displacement of water from the plant tray;
b) A draining adaptor positioned in the bore;
c) A draining restrictor operatively connected into the draining adaptor for controlling water level in the plant tray.

2. A plant tray according to claim 1, further comprising two or more bores positioned within the plant tray.

3. A plant tray according to claim 2, further comprising one or more plugs to seal the two or more bores which does not have a draining adaptor.

4. A plant tray according to claim 1 further comprising a display base.

5. A plant tray according to claim 4 wherein the display base is comprised of concrete blocks.

6. A plant tray according to 4 wherein the display base is comprised of a wooden structure.

7. A plant tray according to claim 4 wherein the plant tray is placed on the display base with one or more apertures for receiving locating pins of the plant tray.

8. A plant tray according to claim 7 wherein the display stand further comprising one or more affixing holes which align with the locking holes of the plant tray to allow a bolt to affix the plant tray to the display base.

9. A potted plant display stand comprising:
a) Two or more plant trays for displaying potted plants;
b) A display base to support the two or more plant trays;
c) One or more bores located within the two or more plant trays;
d) A conduit system interconnecting the two or more plant trays;
e) A draining adaptor positioned within the one or more bores;
f) A draining restrictor positioned in the draining adaptor for controlling the level of water within the two or more plant trays.

10. The potted plant display stand according to claim 9, wherein the one or more bores are positioned within the plant trays to allow the conduit system to interconnect adjacent plant trays.

11. The potted plant display stand according to claim 10 wherein the two or more plant trays have upper lips.

12. The potted plant display stand according to claim 11 wherein the display base is positioned within the upper lips of the two or more plant trays.

13. The potted plant display stand according to claim 12 wherein the upper lips of the two or more plant trays have one or more locating pins that mate with apertures within the display base.

14. The potted plant display stand according to claim 9 further comprising one or more drain plugs seal for the one or more bores of the plant tray.

15. The potted plant display stand according to claim 9 wherein the display stand further comprising one or more pin apertures for receiving locating pins of the plant tray.

16. The potted plant display stand according to claim 15 wherein the display stand further comprising one or more affixing holes which align with locking holes of the plant tray allowing a bolt to affix the plant tray to the display base.

17. The potted plant display stand according to claim 9 wherein the display base contains a plant hanging attachment.

18. The potted plant display stand according to claim 9 further comprising a suction system comprising of one or more tubes and a suction mechanism that transports the water to and away from the potted plant display stand.

19. The potted plant display stand according to claim 9 wherein the display base is made of concrete blocks.

20. The potted plant display stand according to claim 9 wherein the display base is made of a wooden display.
